(19) United States
(12) Patent Application Publication
(10) Pub. No.: US 2024/0042736 A1
(43) Pub. Date: Feb. 8, 2024

(54) SURFACE TREATMENT OF CARBON FIBER EPOXY COMPOSITES THROUGH DIAZONIUM ADMOLECULE MODIFICATION

(71) Applicant: Board of Trustees of Michigan State University, East Lansing, MI (US)

(72) Inventors: Greg M. SWAIN, Owosso, MI (US); Isuri N. DAMMULLA, East Lansing, MI (US)

(73) Assignee: Board of Trustees of Michigan State University, East Lansing, MI (US)

(21) Appl. No.: 18/351,624

(22) Filed: Jul. 13, 2023

Related U.S. Application Data
(60) Provisional application No. 63/389,996, filed on Jul. 18, 2022.

(51) Int. Cl. B32B 15/14; B32B 15/20; B32B 5/12; C25D 9/02; C25D 5/54

(52) U.S. Cl. CPC B32B 15/14; B32B 15/20; B32B 5/12; C25D 9/02; C25D 5/54; B32B 2262/106; B32B 2260/021; B32B 2260/046; B32B 2255/02; B32B 2255/26

(57) ABSTRACT

An assembly that includes a first substrate formed of aluminum or an aluminum alloy; and a second substrate formed of a polymer composite that includes a plurality of carbon fibers. The second substrate is joined to the first substrate in a manner where a surface of exposed carbon fibers contacts the aluminum or aluminum alloy of the first substrate; and an is adlayer formed on the surface of the exposed carbon fibers that is configured to inhibit galvanic corrosion of the first substrate, corrosion of the carbon fibers, and debonding of the polymer of the composite from the carbon fibers upon formation of a galvanic couple between the first substrate and the second substrate.

### CROSS-REFERENCE TO RELATED APPLICATIONS

This application claims the benefit of U.S. Provisional Application No. 63/389,996, filed on Jul. 18, 2022. The entire disclosure of the above application is incorporated herein by reference.

### FEDERAL SUPPORT

This invention was made with government support under N00014-21-1-2686 awarded by the Office of Naval Research. The government has certain rights in the invention.

### FIELD

The present disclosure relates to methods of surface treating exposed carbon fibers of carbon fiber epoxy composites through diazonium adlayer formation, and articles including such surface treated carbon fiber epoxy composites.

### BACKGROUND

This section provides background information related to the present disclosure which is not necessarily prior art.

Aluminum alloys are routinely used in structural components of aircraft and other vehicles due to their low density, high strength, and corrosion resistance. In addition, various industries are looking to further reduce weight in vehicles that use aluminum alloys by incorporating carbon fiber reinforced polymer (CFRP) composites to increase fuel efficiency and the like. The desirable mechanical properties of CFRP composites include a high strength-to-weight ratio, fatigue resistance, corrosion resistance, and damage tolerance. When CFRP composites are used in conjunction with aluminum alloys, the CFRP composite parts are typically joined to the aluminum alloy structural component using a mechanical fastener (e.g., a bolt).

When a CFRP composite is mechanically connected to a structural component made of aluminum alloy, however, it is possible that a layer of condensed moisture forms across the CFRP composite and the structural component made of aluminum. When this occurs, a galvanic couple may be created where exposed carbon fibers of the CFRP composite act as a cathode and the aluminum alloy of the structural component act as an anode. In such an instance, the cathode (i.e., the exposed carbon fibers of the CFRP composite) supports reduction of dissolved oxygen, or other species such as hydrogen ions, in the moisture and the anode (i.e., the aluminum alloy structural component) undergoes oxidation at an accelerated rate (i.e., galvanic corrosion). If corrosion of the aluminum structural alloy is accelerated, the mechanical strength of aluminum structural alloy may be lowered, which is undesirable.

### SUMMARY

This section provides a general summary of the disclosure, and is not a comprehensive disclosure of its full scope or all of its features.

According to a first aspect, the present disclosure provides an assembly that includes a first substrate formed of aluminum or an aluminum alloy; and a second substrate formed of a polymer composite that includes a plurality of carbon fibers. The second substrate is joined to the first substrate in a manner where an exposed surface of the carbon fibers comes into electrical contact with the aluminum or aluminum alloy of the first substrate through a layer of condensed moisture or water; and an is adlayer formed on the exposed surface of the carbon fibers that is configured to inhibit galvanic corrosion of the first substrate upon formation of a galvanic couple between the first substrate and the second substrate.

According to the first aspect, the adlayer is formed of an aryl radical.

According to the first aspect, the adlayer is present on the surface of the carbon fibers in an amount that ranges up to 10 nmol/cm².

According to the first aspect, the adlayer is configured to inhibit degradation of the carbon fibers upon formation of the galvanic couple.

According to the first aspect, the adlayer is configured to inhibit degradation of the polymer composite upon formation of the galvanic couple.

According to a second aspect of the present disclosure, there is provided a method of forming a molecular adlayer on a polymeric composite including a plurality of exposed carbon fibers, comprising placing the composite in a solution including at least one of 4-nitrophenyldiazonium tetrafluoroborate (NP) and 4-nitroazobenzene tetrafluoroborate (NAP), wherein the molecular adlayer is formed by applying a potential to the carbon fibers to form the molecular adlayer by an electrochemically-assisted mechanism, or the adlayer is spontaneously formed by leaving the polymeric composite in the solution for a period up to 24 hours.

According to the second aspect, the solution includes acetonitrile, and up to 5 mM of at least one of the NP and NAP dissolved in 0.1 M tetrabutylammonium tetrafluoroborate (NBu₄BF₄) supporting electrolyte.

According to the second aspect, when the molecular adlayer is formed using the electrochemically-assisted mechanism, the potential applied to the carbon fibers located in the solution is scanned from 0.6 to −0.5 V at 50 mV/s.

According to the second aspect, the potential electrochemically reduces the at least one of NP and NAP, and attaches an aryl radical to the carbon fibers to form the adlayer.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side-perspective view of a lap joint assembly including a first substrate and a second substrate joined by a fastener;

FIG. 2 is a top-perspective view of the lap joint assembly shown in FIG. 1;

FIG. 3A is a scanning electron micrograph of the second substrate;

FIG. 3B is a magnification of FIG. 3A;

FIG. 4 illustrates an example chemical reaction that may be used to form an adlayer on a carbon fiber according to an aspect of the present disclosure;

FIGS. 5A and 5B are repetitive cyclic voltametric curves that evidence formation of an adlayer on a carbon fiber;

FIGS. 6A and 6B are Raman spectra that evidence formation of an adlayer on an exposed carbon fiber of a composite;

FIG. 7A shows trivalent chromium process (TCP) conversion coated aluminum substrate before exposure to a salt spray test;

FIG. 7B shows a non-TCP-coated aluminum substrate after being joined to a carbon fiber substrate that does not include an adlayer and subjected to a salt spray test;

FIG. 7C shows an TCP-coated aluminum substrate after being joined to a carbon fiber substrate that does not include an adlayer and subjected to a salt spray test;

FIG. 7D shows an TCP-coated aluminum substrate after being joined to a carbon fiber substrate that includes an NP adlayer and subjected to a salt spray test;

FIG. 7E shows an TCP-coated aluminum substrate after being joined to a carbon fiber substrate that includes an NAP adlayer and subjected to a salt spray test;

FIG. 8 is a graph illustrating weight loss and corrosion intensity of the substrates shown in FIGS. 7B-7E;

FIGS. 9A and 9B are Raman spectra of carbon fiber substrates including adlayers after being exposed to a salt spray test;

FIG. 10A is a scanning electron micrograph of carbon fibers that do not include an adlayer before being subjected to salt spray testing;

FIG. 10B is a scanning electron micrograph of carbon fibers that do not include an adlayer after being subjected to salt spray testing; and

FIG. 10C is a scanning electron micrograph of carbon fibers that include an adlayer after being subjected to salt spray testing.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

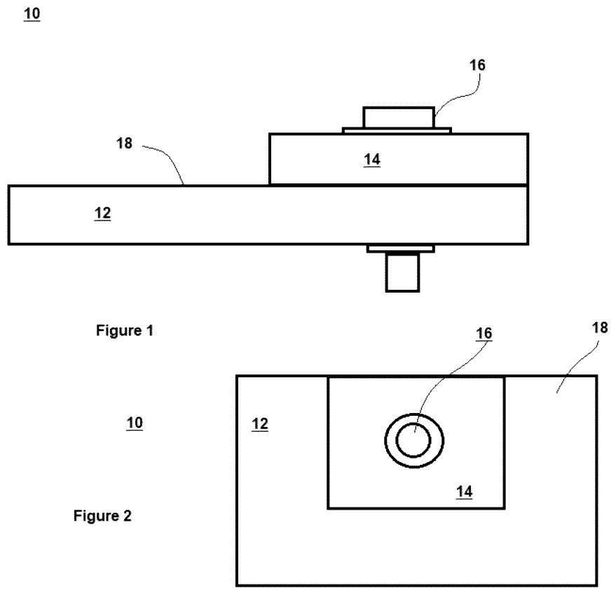

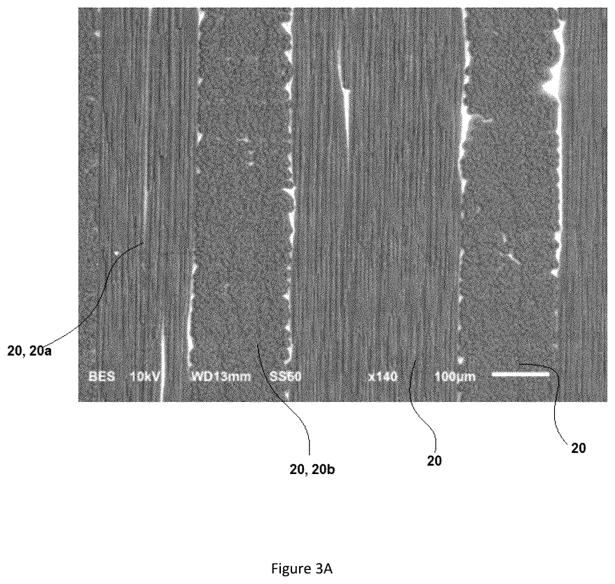

FIGS. 1 and 2 illustrate an assembly 10 including a first substrate 12 and a second substrate 14 attached to each other using a fastener 16. The configuration shown in FIGS. 1 and 2 is a lap joint assembly. First substrate 12 is generally formed of a rigid metallic material, which can be, for example, aluminum or an aluminum alloy. Second substrate 14 may be formed of a polymeric material having carbon fibers dispersed therein to increase the strength of the polymeric material. The polymeric material may serve as a polymeric matrix for supporting each of the carbon fibers. Example polymeric materials include epoxy materials, but other polymeric materials, including cured polymeric materials, are contemplated.

While first substrate 12 is described above as being formed of aluminum or aluminum alloy, it should be understood that additional metallic materials are contemplated. In this regard, any metal or alloy material that is susceptible to oxidation (e.g., steel, magnesium (and alloys thereof), titanium (and alloys thereof), beryllium (and alloys thereof), and the like) is contemplated. In addition, it should be understood that substrate 12 may include an anti-corrosive coating 18. For example, substrate 12 may be subjected to a trivalent chromium process that provides a chromium plating on the substrate 12 that provides anti-corrosive and wear-resistant properties to substrate 12.

First substrate 12 may be, for example, a structure used in an aircraft or some other type of transportation vehicle. In one embodiment, first substrate 12 may form a portion of a wing, fuselage, frame, or some other type of structure used in an aircraft or some other type of vehicle. While materials such as aluminum and aluminum alloys include properties such as a lower density, high strength, and corrosion resistance, there is still a desire to further reduce the weight associated with the aircraft or vehicle. Thus, carbon fiber reinforced polymeric composites (second substrate 14) are increasingly being used in conjunction with aluminum and aluminum alloy materials (first substrate 12) due to the lower mass associated therewith.

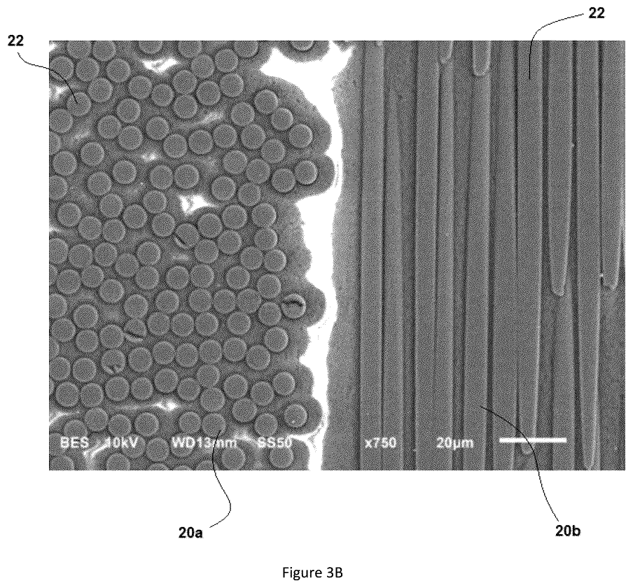

As best shown in FIGS. 3A and 3B, second substrates 14 formed of carbon fiber reinforced polymeric composites include a plurality of layers 20 of carbon fibers 22 that are bonded together using a polymeric material such as, for example, epoxy. The orientation of the fibers 22 in one layer 20a are arranged substantially orthogonal to the orientation of the fibers 22 in an adjacent layer 20b, which increases the strength of the second substrate 14. The number of layers 20 is variable, and may include any number of layers 20 greater than two. For example, the number of layers two, ten, twenty, or greater. In general, the second substrate 14 may be cut from a pre-formed carbon fiber reinforced polymeric composite having the desired number of layers 20. When the second substrate 14 is cut from the pre-formed carbon fiber reinforced polymeric composite, however, the carbon fibers 22 are exposed at the cut edge. The magnification of the carbon fibers 22 in FIG. 3A is 140 times, and the magnification of the carbon fibers 22 in FIG. 3B is 750 times.

When second substrate 14 having exposed carbon fibers 22 at the cut edge is incorporated into assembly 10 and joined to the metal first substrate 12 using fastener 16 or by some other attachment method, it should be understood that water may penetrate the interface between first substrate 12 and second substrate 14. When this occurs, the water may establish an electrical connection between the exposed carbon fibers 22 and the metal material (e.g., aluminum or aluminum alloy) of the first substrate 12. In other words, a galvanic couple is created with the more noble exposed carbon fibers 22 of the second substrate 14 acting as a cathode that supports the reduction of dissolved oxygen, and the less noble aluminum or aluminum alloy of the first substrate 12 acting as a cathode and undergoing oxidation (i.e., galvanic corrosion). This galvanic corrosion of the first substrate 12 may lead to an undesirable reduction in mechanical strength of the first substrate 12 and assembly 10.

In view of the above, the present disclosure is directed to eliminating or at least substantially minimizing the creation of a galvanic couple between the first substrate 12 and the second substrate 14. To eliminate or at least substantially minimize the creation of a galvanic couple between the first substrate 12 and the second substrate 14, an adlayer 24 may be deposited on the exposed carbon fibers 22 of the second substrate 14 that can eliminate or attenuate the rate of galvanic corrosion of the aluminum or aluminum alloy of the first substrate 12 by preventing or inhibiting the cathodic reduction of oxygen when water is present between the first substrate 12 and the second substrate 14. Formation of adlayer 24 blocks active sites on carbon fibers 22 for chemisorption of oxygen (O₂).

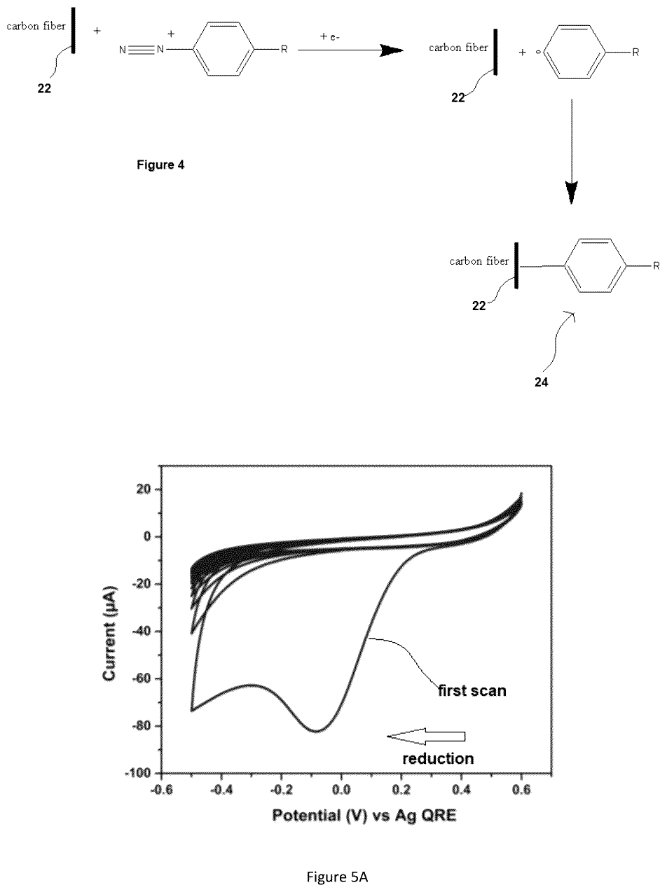

As can be seen in FIG. 4, adlayer 24 may be formed on exposed surfaces of carbon fibers 22 of the second substrate 14 (composite) by attaching or covalently bonding aryl radicals to a surface of the carbon fibers 22. The aryl radicals may be attached to the surface of the carbon fibers 22 through an electrochemical process, as shown in FIG. 4, or by submerging the second substrate 14 having the exposed carbon fibers 22 in a bath including a material that can attach the aryl radicals to the carbon fiber 22 surface. Example materials that can be used to attach the aryl radicals to the carbon fiber 22 surface include aryl diazonium salts such as, for example, 4-nitrophenyldiazonium tetrafluoroborate (NP) and 4-nitroazobenzene tetrafluoroborate (NAP) (as shown in FIG. 4). Other aryl diazonium salts are contemplated and may be selected based on the knowledge of one skilled in the art.

To prepare second substrate 14 for attachment of the adlayer 24, the edge of the second substrate 14 where carbon fibers 22 are exposed was first abraded using wet P1500 grit aluminum oxide sandpaper for about three minutes, which was followed by ultrasonically cleaning the abraded second substrate 14 in ultrapure water for about ten minutes. Then, the edge of the second substrate 14 having the exposed carbon fibers 22 was polished with decreasing grades (e.g., 1 μm, 0.3 μm, and 0.05 μm) of alumina powder slurried in ultrapure water to smooth the surfaces of the carbon fibers 22. After each polishing, the second substrate 14 was rinsed with and ultrasonically cleaned with ultrapure water for about fifteen minutes to remove any polishing residue. A final ultrasonic cleaning was then conducted in a bath of pure acetonitrile for about ten minutes. It should be understood that the abrading and cleaning times are variable.

In this embodiment, the attachment of adlayer 24 was conducted electrochemically. Specifically, the electrochemically assisted surface modification (i.e., attachment of the adlayer 24) of the carbon fibers 22 of the second substrate 14 was performed by cyclic voltammetry in deaerated acetonitrile containing a solution of 5 mM of the selected diazonium salt (e.g., NAP) dissolved in 0.1 M tetrabutylammonium tetrafluoroborate (NBu₄BF₄) supporting electrolyte. A potential was applied to the second substrate 14 located in the solution that was scanned from 0.6 to −0.5 V at 50 mV/s to electrochemically reduce the selected diazonium salt molecules and attach the aryl radical adlayer 24 to the carbon fibers 22. To ensure that the adlayer 24 satisfactorily covered the surface of the carbon fibers 22, twenty-five potential cycles were used. After attachment of the adlayer 24, the second substrate 14 was thoroughly rinsed with water and acetonitrile.

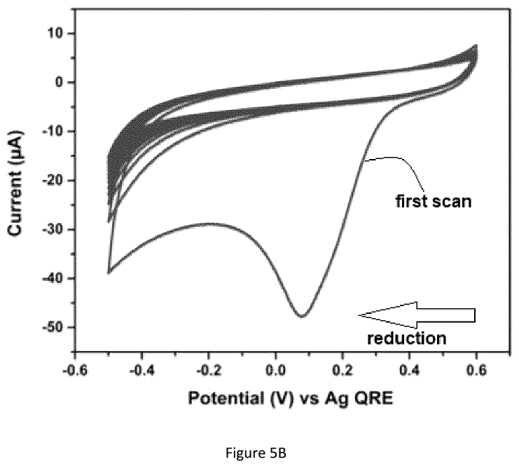

To confirm formation of the adlayer 24, the second substrate 14 was subjected to cyclic voltammograms and Raman spectroscopy. These results were then compared to cyclic voltammograms and Raman spectroscopy of the second substrate 14 that were taken before the electrochemical process of attaching the adlayer 24. FIGS. 5A and 5B are voltametric curves that were recorded for second substrates 14 in which an adlayer 24 as formed on the surfaces of the exposed carbon fibers 22. FIG. 5A illustrates an embodiment where the adlayer 24 was electrochemically formed using NP and FIG. 5B illustrates an embodiment where the adlayer 24 was electrochemically formed using NAP according to the method outlined above. A “scan” was taken after each potential cycle to form the adlayer 24. As shown in each figure, the first scan resulted in a well-defined, irreversible reduction peak at −0.1 V for NP and at 0.1 V for NAP. After each potential cycle and subsequent scan, it can be seen that the size of the subsequent peaks was reduced in size and became grouped together (see, e.g., the upper left corner of each figure), which indicates an inhibition of electron transfer reaction due to the adlayer 24 being formed on exposed carbon fibers 22 of the second substrate 14. Put another way, FIGS. 5A and 5B positively indicate formation and covalent attachment of the adlayer 24 to the exposed carbon fibers 22 of the second substrate 14.

A thickness of the adlayer 24 is adjustable, and may be dependent on the number of potential cycles applied to the second substrate 14 when the second substrate in located in the NP or NAP solution. For example, a thickness of the adlayer 24 may range between 1 μm to 10 μm, or greater. Moreover, the amount of the adlayer 24 per unit area can be up 10 nmol/cm². Regardless of the thickness or amount of the adlayer 24, the adlayer 24 is extremely stable and difficult to remove from the surface of the carbon fibers 22. Indeed, rinsing and ultrasonic cleaning of the second substrate 14 including the adlayer 24 for up to thirty minutes in a solution of acetonitrile produced no change in the cyclic voltametric response, and the adlayer 24 was also found to be stable after subjecting the second substrate 14 including the adlayer 24 to a seven day neutral salt spray. The only way to effectively remove the adlayer 24 from the second substrate 14 was by mechanical abrading and polishing.

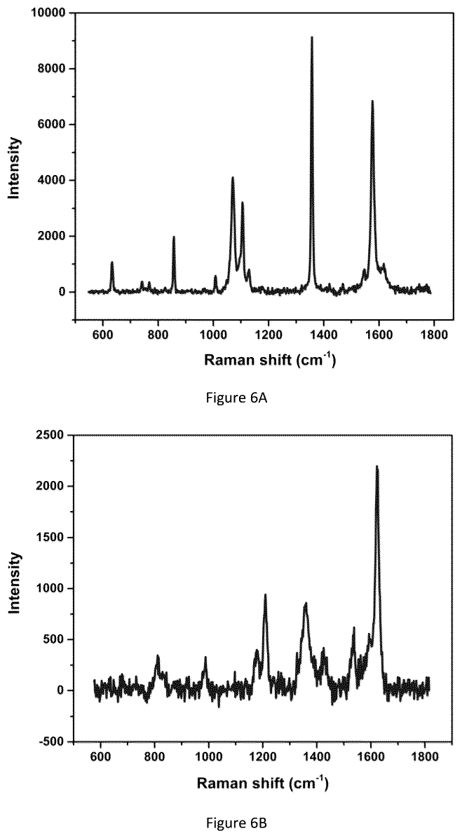

As noted above, Raman spectroscopy was also used to confirm formation of adlayer 24. FIGS. 6A and 6B show, respectively, the Raman spectra of a solid NP salt and the second substrate 14 where the NP salt was used to form the adlayer 24 on the surfaces of the carbon fibers 22 of second substrate 14. When comparing each figure, it can be seen that the peaks that resulted from the scan of solid NP salt (FIG. 6A) are also present when the NP salt was used to form the adlayer 24 on the second substrate 14 (FIG. 6B). Thus, formation and covalent attachment of the adlayer 24 was also confirmed by Raman spectroscopy.

Once formation of adlayer 24 was confirmed, second substrate 14 was attached to first substrate 12 via fastener 16 to form assembly 10 (FIG. 1). Although not required, it should be understood that before assembly 10 is formed, first substrate 12 may be cleaned prior to second substrate 14 being joined thereto using fastener 16. For example, first substrate 12 may be mechanically abraded, ultrasonically cleaned, and polished in a manner similar to that described above for second substrate 14. First substrate 12 may also be subjected to degreasing using an alkaline degreaser, rinsed, and then subjected to trivalent chromium plating. Regardless, after second substrate 14 was attached to first substrate 12 using fastener, 16, the assembly 10 was subjected to neutral salt spray testing to determine whether adlayer 14 prevented or at least substantially minimized formation of a galvanic couple between first and second substrates 12 and 14.

The testing conditions for the neutral salt spray included exposing the assembly 10 to a continuous salt fog (5 wt.% NaCl at 35 degrees C. (+/−1 degree C.)) for seven days according to ASTM B117 (standard practice for operating a salt spray (fog) apparatus). At the conclusion of the seven days, the assembly 10 was removed and the first and second substrates 12, 14 were decoupled and cleaned to remove any salt deposits. The cleaned first and second substrates 12, 14 were then analyzed by digital optical and scanning electron microscopy to determine whether the surface texture changed, whether pits were formed, or whether any other type of corrosion was present.

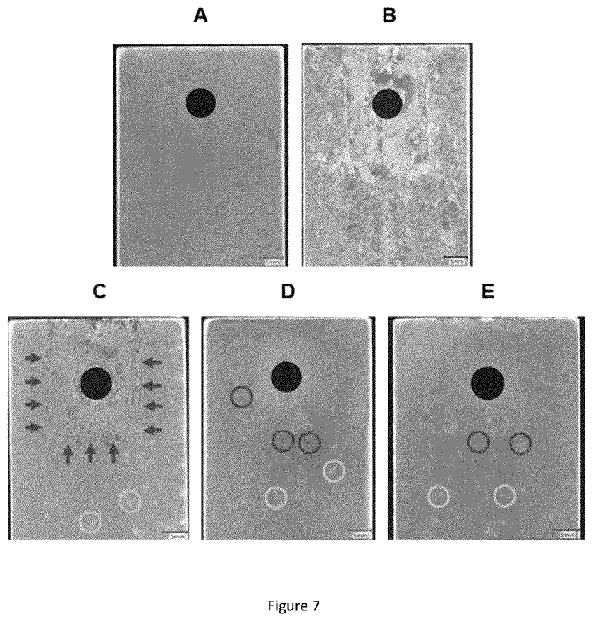

FIGS. 7A to 7E illustrate first substrate 12 before and after being subjected to the above-noted salt spray testing. Each of FIGS. 7A to 7E are digital optical micrographs. FIG. 7A shows a first substrate 12 having a trivalent chromium plating (TCP) before salt spray exposure; FIG. 7B shows a first substrate 12 that does not include the TCP that was joined with an unmodified second substrate 14 (i.e., second substrate 14 did not include adlayer 24); FIG. 7C shows a first substrate 12 having a TCP that was joined with an unmodified second substrate 14 (i.e., second substrate 14 did not include adlayer 24); FIG. 7D shows a first substrate 12 having a TCP that was joined to a second substrate 14 having an adlayer 24 that was formed used NP; and FIG. 7E shows a first substrate 12 having a TCP that was joined to a second substrate 14 having an adlayer 24 that was formed using NAP.

As can be seen in FIG. 7A, the first substrate 12 before being subjected to salt spray testing is devoid of any corrosion. FIG. 7B shows that first substrate 12 is severely corroded after being joined to a second substrate 14 that did not include an adlayer 24, which evidences that a galvanic couple was created between the first substrate 12 and the second substrate 14 that accelerated the corrosion of first substrate 12 (it should be understood that the corrosion shown in FIG. 7B occurred after just three days of exposure to the salt spray rather than the seven days that FIGS. 7C-E illustrate). FIG. 7C show that the inclusion of a TCP on first substrate 12 can assist in preventing corrosion of the first substrate 12 when a galvanic couple is created between the first substrate 12 and the second substrate 14. Nonetheless, FIG. 7C shows significant corrosion. FIGS. 7D and 7E show that the formation of an adlayer 24 prevents or at least substantially minimizes the formation of a galvanic couple between the first substrate 12 and the second substrate 14 such that almost no corrosion developed.

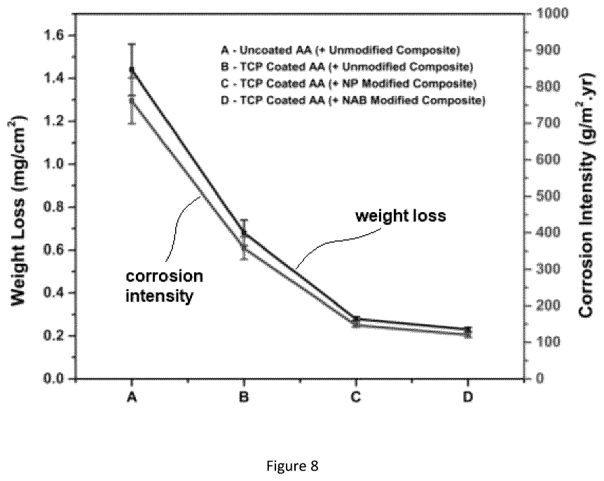

The first substrates 12 of FIGS. 7B to 7E were also weighed before and after being subjected to salt spray testing. FIG. 8 illustrates the amount of weight loss and corrosion intensity for each of the first substrates 12 shown in FIGS. 7B to 7E. As shown in FIG. 8, the non-TCP coated substrate that was joined to an unmodified second substrate 14 (shown in FIG. 7B) exhibited the largest weight loss per square centimeter (Sample A) because of the extensive corrosion damage after only three days of salt spray exposure. The TCP-coated first substrate 12 that was joined to an unmodified second substrate 14 (shown FIG. 7C) exhibited weight loss that was two times less (Sample B) than that exhibited by Sample A, which can be attributed to anodic protection provided by the TCP coating. Notably, Samples C and D where the second substrate 14 included an adlayer formed from NP or NAP exhibited the least amount of weight loss, which can be attributed to the formation of the adlayer 24. Indeed, the weight loss is five times better when an NP-modified adlayer 24 is formed on the carbon fibers 22 and up to seventy-five times between when an NAP-modified adlayer 24 is formed. In view of the above, when the carbon fibers 22 are not treated to include an adlayer 24, significant corrosion can occur which is in sharp contrast to when the carbon fibers 22 are treated to include an adlayer 24 to prevent or substantially minimize galvanic coupling between the first substrate 12 and the second substrate 14.

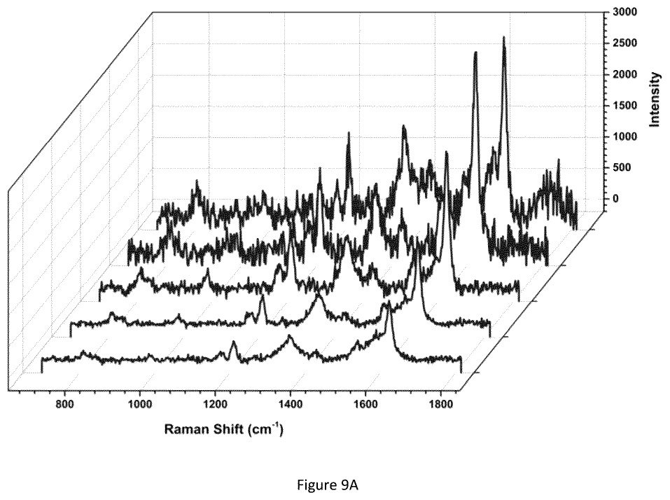

As noted above, the adlayer 24 was found to be stable after subjecting the second substrate 14 including the adlayer 24 to a seven day neutral salt spray. Evidence of the stability of the adlayer 24 after salt spray exposure is illustrated in FIGS. 9A and 9B. FIG. 9A is a Raman spectrum of the second substrate 13 that was modified to include an NP adlayer 24. FIG. 9B is a Raman spectrum of the second substrate 13 that was modified to include an NAP adlayer 24. The Raman spectra were recorded along an 80 μm line scan, and each spectrum was acquired at 1 μm distances. A select number of these scans are illustrated in each of FIG. 9A and 9B. As can be seen in each of these figures, the characteristic peaks associated with NP and NAP are included in each spectrum. The intensity of these peaks is somewhat less than what is shown in FIGS. 6A and 6B, which may suggest that there may be some loss of the adlayer 24 after salt spray exposure. Nonetheless, FIGS. 9A and 9B provide evidence that the adlayers 24 are stably formed even after exposure to the salt spray testing.

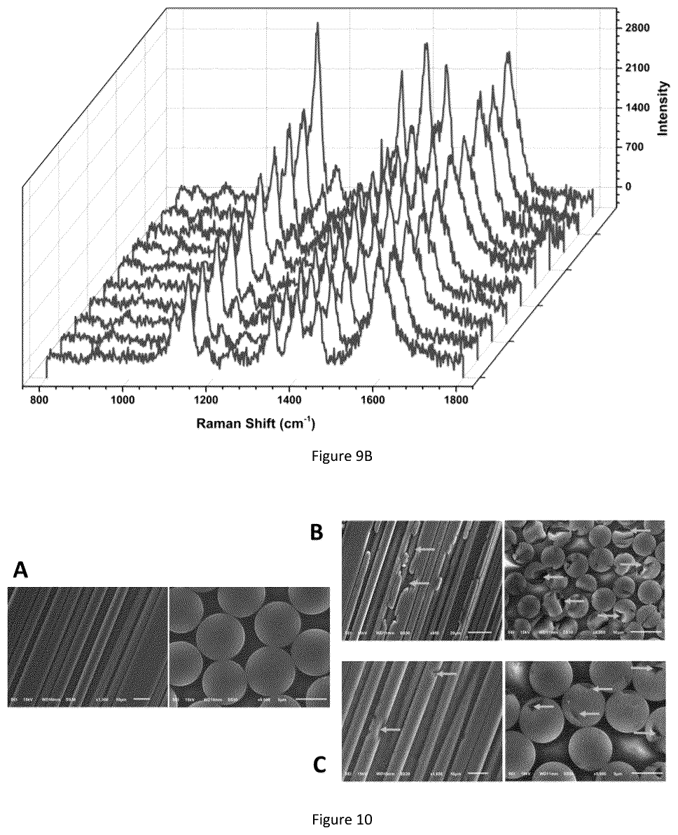

It should be understood that when the carbon fibers 22 are not treated to include an adlayer 24, the carbon fibers 22 themselves may undergo deterioration when a galvanic couple is formed between the first substrate 12 and the second substrate 14. This is believed to be caused by the water between the substrates 12 and 14 undergoing oxidation to form hydrogen peroxide (H₂O₂), which then leads to oxidation of the carbon fibers 22. In addition, changes in pH occur when the galvanic couple is formed, which can affect the integrity of the carbon fibers 22. FIG. 10A is scanning electron micrograph (SEM) of carbon fibers 22 that do not include an adlayer 24 before being coupled to a first substrate 12 and subjected to salt spray testing, and FIG. 10B is an SEM of the carbon fibers 22 after being subjected to salt spray testing and decoupled from the first substrate 12. As can be seen in FIG. 10B (at the arrows), the carbon fibers 22 suffered significant degradation and there was even some detachment of the epoxy material that binds the carbon fibers 22 together. FIG. 10C is an SEM of carbon fibers 22 that have been modified to include an NAP adlayer 24. As can be seen in FIG. 10C, while there is some damage to the carbon fibers 22, the adlayer 24 provides a significant amount of protection to the carbon fibers 22. Thus, formation of the adlayer 24 on the carbon fibers is effective for preventing galvanic corrosion of the aluminum or aluminum alloy first substrate 12 and also for preventing corrosion or degradation of the carbon fibers 12 themselves.

The above-described benefits of the adlayer 24 were found when the adlayer 24 was formed by an electrochemical process. These benefits are also present, and to a greater extent, when the adlayer 24 is spontaneously formed (i.e., without electrochemical assistance). Spontaneous formation of the adlayer 24 on the carbon fibers 22 of the second substrate 14 can occur when the second substrate 14 (after being abraded, cleaned, etc.) is placed in contact or immersed in an acetonitrile solution containing the NP or NAP salt and left for at least a number of hours (e.g., twenty-four hours, or greater). While this process is typically slower in forming the adlayer 24 in comparison to the electrochemical process, the submerging method is effective in forming an adlayer 24 having better coverage on the carbon fibers 22 and to a greater thickness. The adlayers 24 formed by submerging the second substrate 14 in the solution are more compact, have fewer defects, and a greater coverage on the carbon fibers 12 in comparison to the adlayers 24 formed electrochemically. Of course, even better coverage and thickness can be enhanced by prolonging the time that the second substrate 14 is submerged in the acetonitrile/diazonium salt solution. Moreover, while acetonitrile solutions are preferable, it should be understood that other organic solvents may also be used provided that the solvents are compatible with the carbon fibers 22 and the diazonium salts.

The foregoing description of the embodiments has been provided for purposes of illustration and description. It is not intended to be exhaustive or to limit the disclosure. Individual elements or features of a particular embodiment are generally not limited to that embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An assembly, comprising:
a first substrate formed of aluminum or an aluminum alloy;
a second substrate formed of a polymer composite that includes a plurality of carbon fibers, the second substrate being joined to the first substrate in a manner where an exposed surface of the carbon fibers comes into electrical contact with the aluminum or aluminum alloy of the first substrate through a layer of condensed moisture or water; and
an adlayer formed on the exposed surface of the carbon fibers either spontaneously or through an electrochemically-assisted process,
wherein the adlayer is configured to inhibit galvanic corrosion of the first substrate upon formation of a galvanic couple between the first substrate and the second substrate.

2. The assembly according to claim 1, wherein the adlayer is formed of an aryl radical.

3. The assembly according to claim 1, wherein the adlayer is present on the surface of the carbon fibers in an amount that ranges up to 10 nmol/cm².

4. The assembly according to claim 1, wherein the adlayer is configured to inhibit degradation of the carbon fibers upon formation of the galvanic couple.

5. The assembly according to claim 1, wherein the adlayer is configured to inhibit degradation of the polymer composite upon formation of the galvanic couple.

6. The assembly according to claim 1, wherein the plurality of carbon fibers are arranged in the second substrate in a plurality of layers.

7. The assembly according to claim 6, wherein one layer of the plurality of layers includes the carbon fibers arranged in a first direction, and another layer of the plurality of layers that is arranged adjacent to the one layer includes the carbon fibers arranged in a second and orthogonal direction.

8. The assembly according to claim 1, wherein a thickness of the adlayer is in the range of 1 μm to 10 μm.

9. The assembly according to claim 1, wherein a polymer of the polymer composite is an epoxy.

10. The assembly according to claim 1, wherein the adlayer is covalently bonded to the plurality of carbon fibers.

11. A method of forming a molecular adlayer on a polymeric composite including a plurality of exposed carbon fibers, comprising placing the composite in a solution including at least one of 4-nitrophenyldiazonium tetrafluoroborate (NP) and 4-nitroazobenzene tetrafluoroborate (NAP), wherein the molecular adlayer is formed by applying a potential to the carbon fibers to form the molecular adlayer by an electrochemically-assisted mechanism, or the adlayer is spontaneously formed by leaving the polymeric composite in the solution for a period up to 24 hours.

12. The method according to claim 11, wherein the solution includes acetonitrile, and up to 5 mM of at least one of the NP and NAP dissolved in a 0.1 M tetrabutylammonium tetrafluoroborate (NBu₄BF₄) supporting electrolyte.

13. The method according to claim 11, wherein when the molecular adlayer is formed using the electrochemically-assisted mechanism, the potential applied to the carbon fibers located in the solution is scanned from 0.6 to −0.5 V at 50 m V/s.

14. The method according to claim 13, wherein the potential electrochemically reduces the at least one of NP and NAP, and attaches an aryl radical to the carbon fibers to form the adlayer.

15. The method according to claim 13, wherein the potential is applied to the carbon fibers over a plurality of cycles that result in the adlayer having a thickness in the range of 1 μm to 10 μm.

16. The method according to claim 13, wherein the potential is applied to the carbon fibers over a plurality of cycles that result in the adlayer being present on the surface of the carbon fibers in an amount that ranges up to 10 nmol/cm².

17. A method of forming a molecular adlayer on a plurality of exposed carbon fibers of a polymeric composite including the plurality of exposed carbon fibers, comprising:
placing the polymer composite in a solution including at least one of 4-nitrophenyldiazonium tetrafluoroborate (NP) and 4-nitroazobenzene tetrafluoroborate (NAP);
applying a potential to the plurality of exposed carbon fibers to form the molecular adlayer on the plurality of exposed carbon fibers, the potential being applied to the plurality of carbon fibers by scanning from 0.6 to −0.5 V at 50 mV/s,
wherein the potential is applied to the plurality of exposed carbon fibers over a plurality of cycles.

18. The method according to claim 17, wherein the solution includes acetonitrile, and up to 5 mM of at least one of the NP and NAP dissolved in a 0.1 M tetrabutylammonium tetrafluoroborate (NBu₄BF₄) supporting electrolyte.

19. The method according to claim 17, wherein the potential electrochemically reduces the at least one of NP and NAP, and attaches an aryl radical to the plurality of exposed carbon fibers to form the adlayer.

20. The method according to claim 17, wherein the adlayer is covalently bonded to the plurality of exposed carbon fibers.
